(19) United States
(12) Patent Application Publication
(10) Pub. No.: US 2010/0039981 A1
(43) Pub. Date: Feb. 18, 2010

(54) HANDOVER METHOD USING RELAY STATION HAVING HANDOVER CONTROL FUNCTION AND MULTI-HOP RELAY SYSTEM

(76) Inventors: Yong-Su Lee, Seoul (KR); Woosin Lee, Daejeon-city (KR); Young-Uk Chung, Daejeon-city (KR); Hyukjoon Lee, Daejeon-city (KR); Yong-Hoon Choi, Daejeon-city (KR); Young-Ii Kim, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/522,498

(22) PCT Filed: Jan. 7, 2008
(86) PCT No.: PCT/KR08/00066

§ 371 Date: Jul. 8, 2009

(30) Foreign Application Priority Data
Jan. 18, 2007 (KR) 10-2007-0001952
Apr. 10, 2007 (KR) 10-2007-0035305
Aug. 24, 2007 (KR) 10-2007-0085631

(51) Int. Cl. H04W 36/00; H04B 7/26

(52) U.S. Cl. 370/315; 370/331; 455/436

(57) ABSTRACT

Provided are a handover method using a relay station having a handover control function and a multi-hop relay system. When handover of mobile stations connected to a relay station is required, the relay station negotiates handover of the mobile stations with a base station by exchanging a handover request message and a handover response message. Upon execution of handover of the mobile stations, the relay station collects handover results of the mobile stations and transmits the handover results to the base station. The base station then updates information about the handed-over mobile stations.

### TECHNICAL FIELD

The present invention generally relates to a handover control method in a multi-hop relay network, and more particularly, to a handover method for mobile stations connected to a relay station having a handover processing function. This work was supported by the IT R&D program of MIC/IITA [2006-S-011-01, Development of Relay/mesh communication system for multi-hop WiBro].

### BACKGROUND ART

Institute of Electrical and Electronics Engineers (IEEE) 802.16e defines a method for a base station to control handover of a mobile station. However, according to a conventional method, when a relay station ends a service due to various causes like when a nomadic relay station that is temporarily installed in order to provide a service terminates the service, a mobile station connected to the relay station misses a connection point to a network and thus has to resume initial connection setup, resulting in inefficiency.

### DISCLOSURE OF INVENTION

### Technical Problem

The present invention provides a handover method and system in which a relay station having a handover control function negotiates handover of mobile stations with a base station and collectively reports the base station of handover results of the mobile stations when handover of the mobile stations are required for service termination of the relay station or other purposes.

### Technical Solution

According to one aspect of the present invention, there is provided a handover method for a relay station in a multi-hop relay system including a base station, the relay station, and mobile stations. The handover method includes transmitting a handover request message including a list of handover-target mobile stations to the base station, receiving a handover response message including information of whether handover of the handover-target mobile stations is acceptable from the base station, executing handover of mobile stations whose handover is accepted by the base station, and transmitting a handover execution message including handover results of the mobile stations to the base station.

According to another aspect of the present invention, there is provided a handover method for a base station in a multi-hop relay system including the base station, a relay station, and mobile stations. The handover method includes receiving a handover request message including a list of handover-target mobile stations from the relay station, determining whether handover of the handover-target mobile stations is acceptable, transmitting a handover response message including a determination result to the relay station, receiving a handover execution message including handover results of mobile stations whose handover is accepted from the relay station, and updating information about the handed-over mobile stations based on the handover execution message.

According to another aspect of the present invention, there is provided a multi-hop relay system including a relay station transmitting a handover request message comprising a list of handover-target mobile stations to the base station and a base station determining whether handover of the handover-target mobile stations included in the handover request message is acceptable and transmitting a handover response message including a determination result to the relay station, in which the relay station executes handover of mobile stations whose handover is accepted based on the handover response message and transmits a handover execution message including handover results of the mobile stations to the base station, and the base station updates information about the handed-over mobile stations based on the handover execution message.

### ADVANTAGEOUS EFFECTS

According to the present invention, a relay station having a handover control function controls handover of mobile stations and collectively reports a base station of handover results of the mobile stations, thereby improving efficiency in service termination of the relay station or in terms of resource management and maintaining a correct downlink path from the base station to the mobile stations.

### DESCRIPTION OF DRAWINGS

The above and other features and advantages of the present invention will become more apparent by describing in detail an exemplary embodiment thereof with reference to the attached drawings in which:

FIG. 1 is a flowchart illustrating a handover method using a relay station having a handover control function according to an exemplary embodiment of the present invention; and

FIG. 2 illustrates the format of a handover execution message used for a relay station to report a base station of handover results of mobile stations in FIG. 1.

### BEST MODE

According to one aspect of the present invention, there is provided a handover method for a relay station in a multi-hop relay system including a base station, the relay station, and mobile stations. The handover method includes transmitting a handover request message including a list of handover-target mobile stations to the base station, receiving a handover response message including information of whether handover of the handover-target mobile stations is acceptable from the base station, executing handover of mobile stations whose handover is accepted by the base station, and transmitting a handover execution message including handover results of the mobile stations to the base station.

According to another aspect of the present invention, there is provided a handover method for a base station in a multi-hop relay system including the base station, a relay station, and mobile stations. The handover method includes receiving a handover request message including a list of handover-target mobile stations from the relay station, determining whether handover of the handover-target mobile stations is acceptable, transmitting a handover response message including a determination result to the relay station, receiving a handover execution message including handover results of mobile stations whose handover is accepted from the relay station, and updating information about the handed-over mobile stations based on the handover execution message.

According to another aspect of the present invention, there is provided a multi-hop relay system including a relay station transmitting a handover request message comprising a list of handover-target mobile stations to the base station and a base station determining whether handover of the handover-target mobile stations included in the handover request message is acceptable and transmitting a handover response message including a determination result to the relay station, in which the relay station executes handover of mobile stations whose handover is accepted based on the handover response message and transmits a handover execution message including handover results of the mobile stations to the base station, and the base station updates information about the handed-over mobile stations based on the handover execution message.

### Mode for Invention

Hereinafter, an exemplary embodiment of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

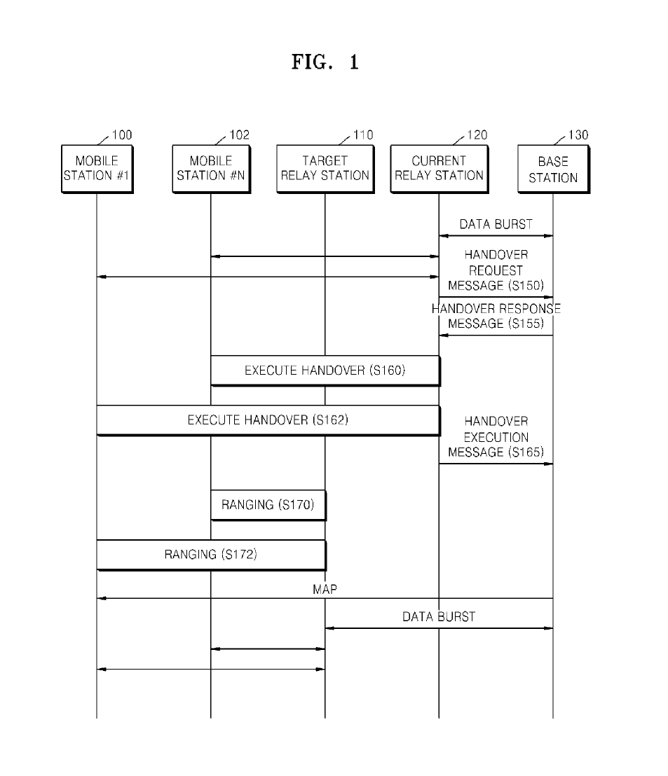

FIG. 1 is a flowchart illustrating a handover method using a relay station having a handover control function according to an exemplary embodiment of the present invention.

Referring to FIG. 1, a multi-hop relay system includes relay stations 110 and 120, a mobile station #1 100 and a mobile station #n 102 connected to the current relay station 120, and a base station 130. In FIG. 1, the mobile stations 100 and 102 are handed over to the target relay station 110.

Upon receipt of a handover request (MOB_MSHO-REQ) message from a mobile station, the current relay station 120 having a handover control function selects a new access station in order to transmit a handover response (MOB_MSHO-RSP) message to the mobile station. When handover of mobile stations is required, the current relay station 120 negotiates the handover by exchanging a handover request (MOB_RSHO-REQ) message and a handover response (MOB_RSHO-RSP) message, and generates and transmits a handover request message to the mobile stations, thereby controlling handover of the mobile stations. The MOB_MSHO-REQ message, the MOB_MSHO-RSP message, the MOB_RSHO-REQ message, and the MOB_RSHO-RSP message are defined in IEEE 802.16e.

When handover of the mobile stations 100 and 102 connected to the current relay station 120 is required for service end of the current relay station 120 or other purposes, the current relay station 120 transmits a handover request message to the base station 130 in operation S150. The handover request message includes reasons for handover request and a list of the handover-target mobile stations 100 and 102. The reasons for handover request may include a case when a relay station ends a service, a case when link quality between a relay station and a base station is low, a case when resource management is required due to a change in the number of mobile stations connected to a relay station, and a case when management of the number of mobile stations connected to a relay station is required.

Upon receipt of a handover request message from the current relay station 120, the base station 130 generates a handover response message including information of whether handover of the handover-target mobile stations 100 and 102 included in the handover request message is acceptable and transmits the handover response message to the current relay station 120 in operation S155.

The handover request message and the handover response message may be the MOB_RSHO-REQ message and the MOB-RSHO-RSP message defined in IEEE 802.16e and may also be defined in different ways.

Upon receipt of the handover response message from the base station 130, the current relay station 120 transmits a handover request message to the mobile stations 100 and 102 whose handover is acceptable, thereby controlling handover of the mobile stations 100 and 102 in operations S160 and S162. The handover request message may be a MOB_BSHO-REQ message defined in IEEE 802.16e and may also be defined in different ways.

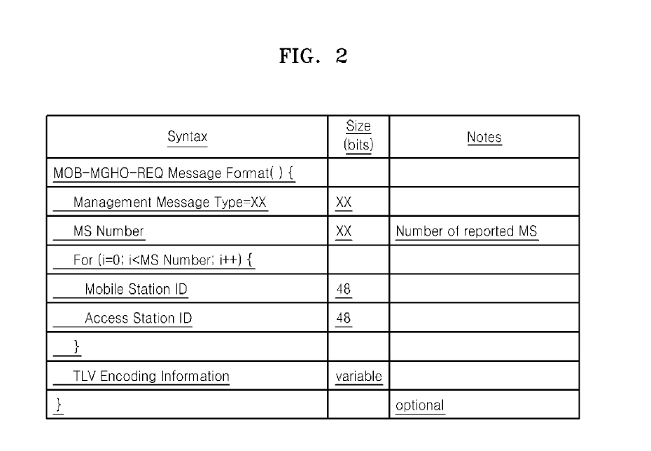

Upon receipt of a handover execution message from the mobile stations 100 and 102, the current relay station 120 generates a handover execution message including handover results of the mobile stations 100 and 102 and transmits the handover execution message to the base station 130 in operation S165. In other words, the current relay station 120 obtains an address of a new access station for the mobile stations 100 and 102 from the handover execution message received from the mobile stations 100 and 102 and transmits the generated handover execution message including the obtained address of the access station to the base station 130 for downlink path establishment. The handover execution message generated by the current relay station 120 may be the MOB_MGHO-REQ message illustrated in FIG. 2 and may also be defined in different ways.

Upon receipt of the handover execution message from the current relay station 120, the base station 130 updates information about the mobile stations 100 and 102 based on the address of the new access station and the like included in the handover execution message. The mobile stations 100 and 102 then perform ranging with the target base station 110 in operations S170 and S172.

FIG. 2 illustrates the format of a handover execution message used for the current relay station 120 to report the base station 130 of handover results of the mobile stations 100 and 102 in FIG. 1. Referring to FIG. 2, the handover execution (MOB_MGHO-REQ) message includes IDs of the handed-over mobile stations 100 and 102 and an ID of the new access station which the mobile stations 100 and 102 newly enter.

The present invention can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves. The computer-readable recording medium can also be distributed over network coupled computer systems so that the computer-readable code is stored and executed in a distributed fashion.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

1. A handover method for a relay station in a multi-hop relay system comprising a base station, the relay station, and mobile stations, the handover method comprising:
transmitting a handover request message comprising a list of handover-target mobile stations to the base station;
receiving a handover response message comprising information of whether handover of the handover-target mobile stations is acceptable from the base station;
executing handover of mobile stations whose handover is accepted by the base station; and
transmitting a handover execution message comprising handover results of the mobile stations to the base station.

2. The handover method of claim 1, wherein the handover execution message comprises an address of a new access station for the mobile stations.

3. A handover method for a base station in a multi-hop relay system comprising the base station, a relay station, and mobile stations, the handover method comprising:
receiving a handover request message comprising a list of handover-target mobile stations from the relay station;
determining whether handover of the handover-target mobile stations is acceptable;
transmitting a handover response message comprising a determination result to the relay station;
receiving a handover execution message comprising handover results of mobile stations whose handover is accepted from the relay station; and
updating information about the handed-over mobile stations based on the handover execution message.

4. The handover method of claim 3, wherein the handover execution message comprises an address of a new access station for the mobile stations, and the update of the information about the mobile stations comprises updating a downlink path of the mobile stations based on the address of the access station.

5. A multi-hop relay system comprising:
a relay station transmitting a handover request message comprising a list of handover-target mobile stations to the base station; and
a base station determining whether handover of the handover-target mobile stations included in the handover request message is acceptable and transmitting a handover response message comprising a determination result to the relay station,
wherein the relay station executes handover of mobile stations whose handover is accepted based on the handover response message and transmits a handover execution message comprising handover results of the mobile stations to the base station, and
the base station updates information about the handed-over mobile stations based on the handover execution message.
